(19) United States
(12) Patent Application Publication
(10) Pub. No.: US 2013/0111024 A1
(43) Pub. Date: May 2, 2013

(54) Dynamic Walled Garden

(71) Applicants: Deepinder Singh Setia, San Ramon, CA (US); Pradeep Iyer, Cupertino, CA (US)

(72) Inventors: Deepinder Singh Setia, San Ramon, CA (US); Pradeep Iyer, Cupertino, CA (US)

(21) Appl. No.: 13/282,333

(22) Filed: Oct. 26, 2011

(51) Int. Cl. G06F 15/173

(52) U.S. Cl. 709/225

(57) ABSTRACT

The present disclosure discloses a network device and/or method for generating a dynamic walled garden. The disclosed network device a network device receives an Hypertext Transfer Protocol (HTTP) response from a second network device. The HTTP response comprises one or more web resources, which are the only web resources accessible to unauthenticated clients. The network device further extracts the web resources from the HTTP response, and enforces enforcing an access policy based on the extracted web resources.

### BACKGROUND OF THE INVENTION

The present disclosure relates to resource access controls in a wireless digital network. In particular, the present disclosure relates to configuring access policies to resources dynamically extracted from web server responses.

Wireless digital networks, such as networks operating under Electrical and Electronics Engineers (IEEE) 802.11 standards, are spreading in their popularity and availability. With such popularity, however, come problems of resource access policy configuration. For example, a network may use captive portal technique to force a client to visit a special web page, e.g., for authentication purposes, before the client is allowed to use the Internet. The special web page may allow unauthenticated clients to gain limited access to network resources.

The captive portal technique intercepts all network packets until a user opens a web browser and attempts to access the Internet. At that time, the web browser is redirected to the special web page which may require the user's authentication and/or payment, or which may display a user policy that requires the user to agree. Captive portal technique is widely used in wireless, wired, and/or hybrid networks for resource access control policies.

Since the special web page must be presented to the client, the external web server hosting the captive portal web page must be whitelisted via a walled garden to bypass the authentication process. A walled garden provides one way of controlling resource access policies. A walled garden typically directs an unauthenticated user's navigation within particular areas to allow access to a selection of materials and/or to prevent access to other materials. For example, a walled garden may allow hotel guests who have not paid for Internet service to access contents of the hotel's website. However, when the unpaid guests attempt to access other Internet websites, the guests will be redirected back to the hotel's website. Note also that multiple web servers may be whitelisted if the captive portal web page includes any embedded frames and/or links.

Conventionally, configuration of the walled garden is accomplished by an administrator who manually configures the resource access control policies to include, in the walled garden, the web server (or its domain name) corresponding to the captive portal web page, as well as the frames or links embedded within the captive portal web page. Nevertheless, such manual process is prone to human-made mistakes. Moreover, the manual configuration process may not provide timely updates to the walled garden configuration when the captive portal web page has been updated.

### BRIEF DESCRIPTION OF THE DRAWINGS

The present disclosure may be best understood by referring to the following description and accompanying drawings that are used to illustrate embodiments of the present disclosure.

FIG. 1 shows an exemplary wireless digital network environment according to embodiments of the present disclosure.

FIG. 2 shows an exemplary web interface of a captive portal web page according to embodiments of the present disclosure.

FIG. 3 is a sequence diagram illustrating an exemplary process of dynamic walled garden according to embodiments of the present disclosure.

FIG. 4 is a flowchart illustrating an exemplary process of dynamic walled garden according to embodiments of the present disclosure.

FIG. 5 is a block diagram illustrating a system for dynamic walled garden according to embodiments of the present disclosure.

### DETAILED DESCRIPTION

In the following description, several specific details are presented to provide a thorough understanding. While the context of the disclosure is directed to routing management of wireless networks, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### Overview

Embodiments of the present disclosure relate to resource access controls in a wireless digital network and, particularly, to configuring access policies to resources dynamically extracted from web server responses. Embodiments of the present disclosure provide a solution that dynamically extracts accessible resources from web server responses and configures access policies based on the extracted results.

With the solution provided herein, a network device receives an Hypertext Transfer Protocol (HTTP) response from a second network device. The HTTP response comprises one or more web resources, which are the only web resources accessible to unauthenticated clients. The network device further extracts the web resources from the HTTP response, and enforces enforcing an access policy based on the extracted web resources.

In some embodiments, the network device receives an HTTP request from an unauthenticated client to access a web resource. Then, the network device determines whether access to the web resource by the unauthenticated client is permitted based on the access policy. In response to access to the web resource not being permitted, the network device forwards the HTTP request to the second network device, such as a device corresponding to a captive portal.

In some embodiments, to extract the web resources from the HTTP response, the network device scans source code of the HTTP response to detect a tag, which includes a Uniform Resource Locator (URL) link to a web resource. If such tag is detected, the network device further parses the URL link to retrieve a domain name associated with the web resource, and stores the domain name in the access policy to allow future access to the web resource from unauthenticated clients in response to the domain name not being existed in the access policy.

### Computing Environment

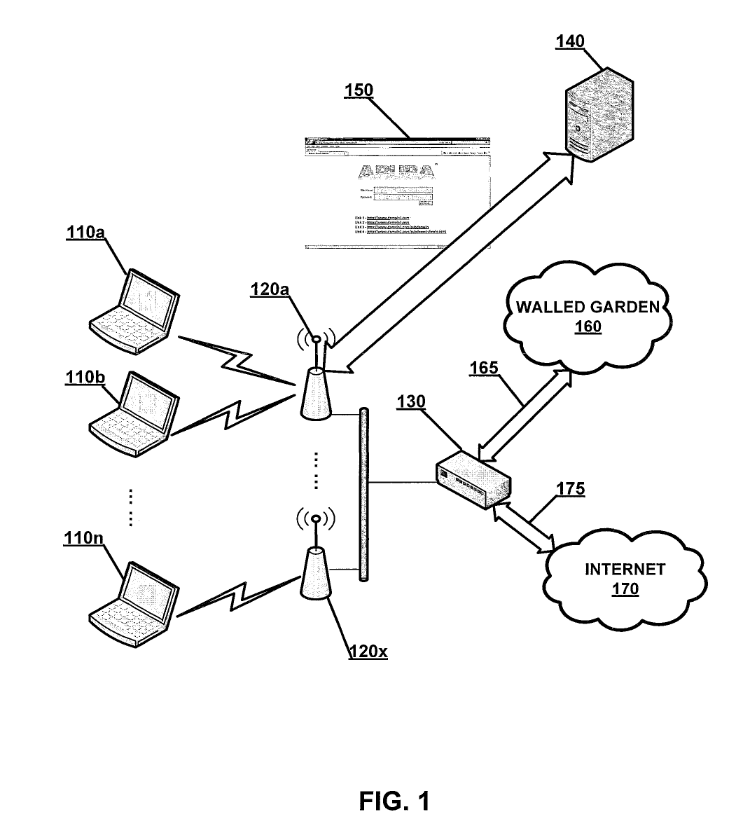

FIG. 1 shows an exemplary wireless digital network environment according to embodiments of the present disclosure. FIG. 1 includes a plurality of wireless stations 110a -110n which are coupled to a plurality of access points 120a -120x via wireless radio links. Access points 120a -120x may optionally be coupled to a controller, a switch, a router, or any other management network device 130. In some embodiments, one or more of access points 120a -120x may be elected as a virtual controller to provide for network management functions. In addition, access points 120a -120x and/or management network device 130 can be further coupled to one or more network servers, such as a Domain Name System (DNS) server, a Dynamic Host Configuration Protocol (DHCP) server, a captive portal server, a web server, etc.

In particular, in the example illustrated in FIG. 1, access point 120a is coupled to a captive portal server 140. An access point (also referred to as “AP”) is a network device that allows wireless clients or stations (STAs) to connect to a wired network using wireless standards. The access point can relay data between the wireless clients/stations and other wired network devices on the network. When unauthenticated wireless client 110a associates with access point 120a and attempts to access an Internet website through a web browser, the web browser resolves the DNS address of the Internet website, and issues an Hypertext Transfer Protocol (HTTP) request to access point 120a.

When access point 120a receives the HTTP request from unauthenticated wireless client 110a, access point 120a will check to determine whether the Internet website requested by wireless client 110a is in a walled garden or a whitelist associated with captive portal server 140. Captive portal server 140 hosts a special captive portal web page 150 that must be presented to unauthenticated wireless client 110a. Special captive portal web page 150 may require the user's authentication and/or payment, or which may display a user policy that requires the user to agree. In addition, special captive portal web page 150 also may include one or more links, icons, or forms that provide access to additional websites that unauthenticated users may navigate to. This selection of materials is often referred to as a “walled garden.” Thus, a walled garden allows for limited navigation by unauthenticated wireless client 110a. For example, unauthenticated wireless client 110a may have access to a selection of materials and at the same time be prevented from accessing to other materials without proper authentication.

If the requested Internet website is included in the walled garden resources, the request will be forwarded to walled garden 160 through communication 165 between the wireless network and the walled garden resources. Note that the walled garden resources may be internal or external to the web domain associated with special captive portal web page 150. Furthermore, the HTTP response from walled garden 160 will be received by access point 120a, and relayed back to wireless client 110a.

If, however, the Internet website that wireless client 110a attempts to access is not within walled garden 160 or a whitelist, access point 120a will redirect the request to captive portal server 140. Captive portal server 140 will then reply with captive portal web page 150. Subsequently, access point 120a will parse captive portal web page 150 received from captive portal server 140 to extract a set of accessible resource domains. The set of accessible resource domains may include, but not limited to, any embedded hyperlinks referred to by a text, an image, an icon, a web form, etc.

Also, access point 120a will dynamically add the domain name corresponding to special captive portal web page 150 along with the set of accessible resource domains (if any) to the walled garden, such that subsequent access requests to web resources in these domains will be allowed automatically.

### Captive Portal Web Interface

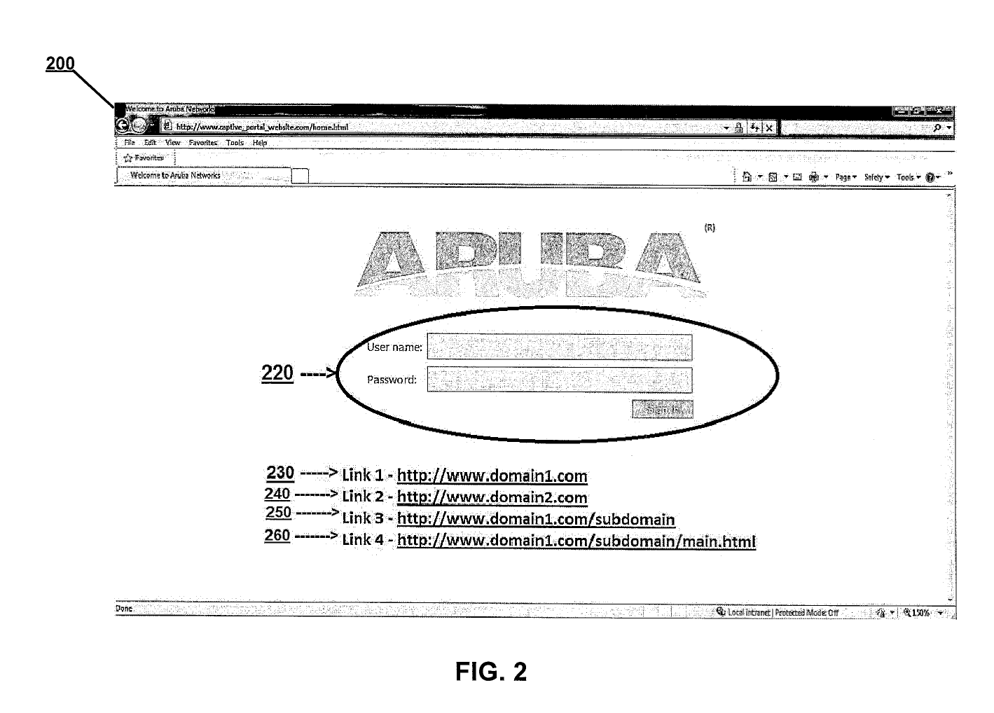

FIG. 2 shows an exemplary web interface of a captive portal web page. In this example, captive portal web page 200 includes a web form 220 for user authentication, and a plurality of web links 230-260 that provide unauthenticated users limited ability to navigate web resources within the walled garden.

Specifically, in the example illustrated in FIG. 2, the plurality of web links include “Link 1” 230, which is a hypertext link to http://www.domain1.com; “Link 2” 240, which is a hypertext link to a web domain http://www.domain2.com; “Link 3” 250, which is a hypertext link to a web sub domain http://www.domain1.com/subdomain; and “Link 4” 260, which is a hypertext link to a web page http://www.domain1.com/subdomain/main.html. Note that, although not depicted, sub domain site may also use such Uniform Resource Locator (URL) as http://subdomain.domain1.com.

Conventionally, an administrator needs to manually insert the additional accessible web resources on captive portal web page 200 to a whitelist in order to allow unauthenticated users access these web resources. With technology disclosed in the present disclosure, an access point or another management network device can automatically parse captive portal web page 200 to look for any embedded hyperlinks upon receiving the HTTP response from the captive portal server. In some embodiments, the HTTP response can be a response to a request from a wireless client. In other embodiments, the HTTP response can be a response to a synthetic access request to captive portal server initiated by an access point.

In the illustrated example, the access point or other management network device will extract the following URLs from the source code of the received HTTP response page:
http://www.domain1.com
http://www.domain2.com
http://www.domain1.com/subdomain
http://www.domain1.com/subdomain/main.html

To extract these URLs, the disclosed system scans the source code of the HTTP response page for any tags that indicate a hyperlink. The tags may be associated with a text, an image, an icon, an object, a web form, a control, and so on. In some embodiments, the tags may include prefixes such as “src,” “href,” “action,” and so on. Next, the system extracts the portion of the tag that includes the URL, and determines the web domain corresponding to the extracted URL.

The system can then dynamically build a whitelist corresponding to a wall garden associated with the captive portal. The whitelist would typically include the web domain corresponding to captive portal web page 200, e.g., http://www.captive_portal_website.com as illustrated in FIG. 2. In addition, the system can insert the web domains corresponding to the extracted URLs into the whitelist. In some embodiments, the disclosed system will also automatically remove redundant domain names, and only insert unique web domains. In some embodiments, the URLs are analyzed and processed to obtain only the web domain name by removing any sub domain names and/or web file names. For example, the sub domain name (“subdomain”) and the web file name (“main.html”) from the URLs in “Link 3” 250 and “Link 4” 260 will be removed to obtain the domain name (“domain1.com”) correspond to both “Link 3” 250 and “Link 4” 260. Note that, in some websites, the sub domain names may be in a format like http://subdomain.domain1.com. When analyzing and processing such URLs, the subdomain portion of the URL will be removed to obtain the domain name (“domain1.com”). In other embodiments, the URLs can be analyzed and processed to obtain any desired level of web domain and/or sub domain names.

In some embodiments, because all of “Link 1 230,” “Link 3” 250, and “Link 4” 260 correspond to the same domain name (“domain1.com”), only one instance of “domain1.com” will be included in the dynamically generated whitelist for the wall garden.

### Exemplary Scenario for Dynamic Walled Garden

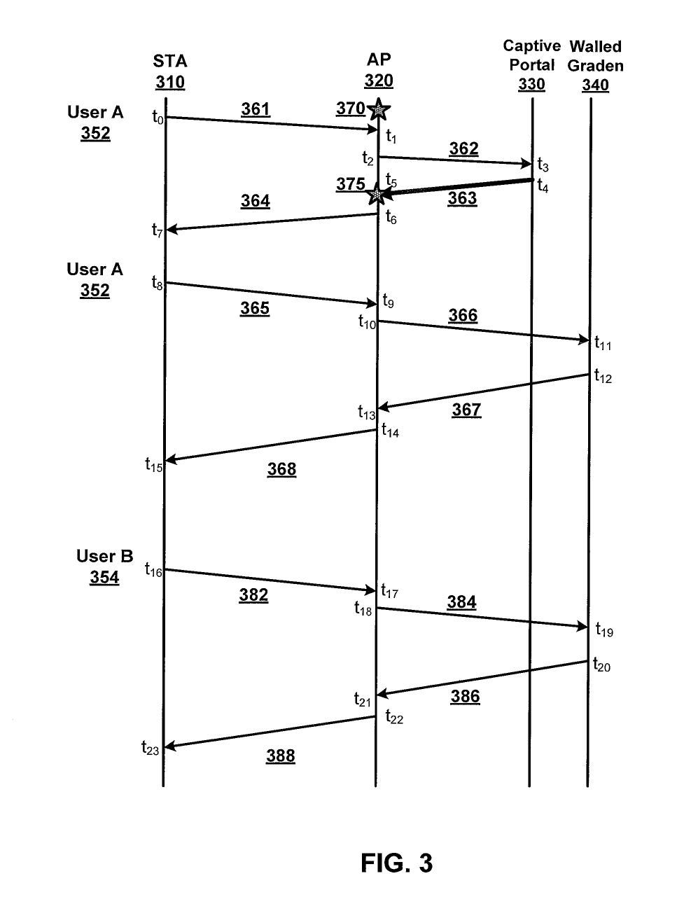

FIG. 3 is a sequence diagram illustrating an exemplary process of dynamic walled garden. FIG. 3 includes a wireless station (STA) 310, an access point (AP) 320, a captive portal server 330, and a walled garden 340. These entities can be deployed in a networking environment illustrated in FIG. 1 as followings: wireless station (STA) 310 in FIG. 3 can be deployed as any one of wireless clients 110a -110n in FIG. 1; access point (AP) 320 can be deployed as any one of access points 120a -120x; captive portal server 330 can be deployed as captive portal server 140; and walled garden 340 can be deployed as walled garden 160.

Before any user attempts to access any web resources, AP 320 would keep a whitelist 370, which initially includes only the statically configured domain name corresponding to captive portal 330. At time point t₀, when a first user, user A 352, sends request 361 to AP 320, requesting to access an external website that is not included in wall garden 340. After AP 320 receives the request at time point t₁, AP 320 checks whitelist 370 to determine whether the requested external website exists in whitelist 370 at that time. In this case, AP 320 determines that the requested external website does not exist in whitelist 370, and therefore redirects request 362 to statically configured captive portal 330 at time point t₂. Captive portal 330 receives redirected request 362 at time point t₃ and sends a response 363 at time point t₄.

Upon receiving request 363 at time point t₅, AP 320 dynamically analyzes and processes response 363 to generate an updated whitelist 375. Specifically, AP 320 scans the source code of response 363 received from captive portal 330 for any tags that indicate a hyperlink. The tags could be associated with any text, image, icon, object, web control, etc. Subsequently, AP 320 extracts the portion of the tag that includes the URL, and identifies the web domain corresponding to the extracted URL. If one or more such web domains are identified, AP 320 then inserts the web domains into whitelist 375 to generate the updated whitelist. During this operation, only unique web domain names will be inserted, and sub domains and/or web pages are truncated from the URL. Therefore, in the example illustrated in FIG. 2, at time point t₅, AP 320 will insert additional domain names such as “domain1.com” and “domain2.com” to the updated whitelist.

At time point t₆, AP 320 relays response 364 back to user A 352 at wireless station 310, which receives response 364 at time point t₇. Response 364 may require user A 352's authentication and/or payment, or which may display a user policy that requires user A 352 to consent.

For purpose of illustration only, assuming that response 365 includes captive portal web page 200 as illustrated in FIG. 2. Let's further assume that user A 352 does not possess sufficient credential to satisfy the authentication requirement of captive portal web page 200, but decides that he/she would rather like to visit http://www.domain1.com/subdomain/main.html. Thus, user A 352 sends out a new request 365 at time point t₈. AP 320 receives new request 365 from user A 352 at time point L. AP 320 will then extract the domain name (i.e., “domain1.com” in this example) corresponding to the website or web page that user A 352 requested to visit in request 365. Next, AP 320 compares the extracted domain name to the updated whitelist 375. Because whitelist 375 has been updated to include both “domain1.com” and “domain2.com” at time point t₅, AP 320 will determine that the requested page in request 365 is within the wall garden. Therefore, AP 320 will allow user A 352's request and pass through request 366 to wall garden 340 at time point t₁₀. Accordingly, Wall garden 340 receives request 366 at time point t₁₁ and replies with response 367 at time point t₁₂. AP 320 receives response 367 at time point t₁₃, and relays back response 368 to user A 352 at wireless station 310 at time point t₁₄ in response. Finally, relayed response 368 is received by wireless station 310 at time point t₁₅.

As another example, let's further assume that, thereafter at time point t₁₆, user B 354 likewise sends a request 382 to AP 320, requesting to access http://www.domain2.com which happens to be a page within walled garden 340. Even though no previous users have requested to access this domain, because at time point t₅, AP 320 has inserted “domain2.com” to whitelist 375, AP 320 will find out, at time point t₁₇, that “domain2.com” exists in the current whitelist 375. Therefore, the requested access will be permitted and AP 320 will forward request 384 to walled garden 340 at time point t₁₈. Walled garden 340 receives request 384 at time point t₁₉, and replies with response 386 at time point t₂₀. Moreover, AP 320 receives response 386 at time point t₂₁, and relays back response 388 to user B 354 at wireless station 310 at time point t₂₂ in response. Subsequently, relayed response 388 is received by wireless station 310 at time point t₂₃.

In some embodiments, a threshold of the number of domains in the whitelist of the walled garden can be predefined. Moreover, each entry is associated with a timestamp indicating the last time the domain was updated by AP 320 or accessed by any wireless client stations 310. In some embodiments, when the predefined threshold is reached, AP 320 will discard the least recently used entry to make space for any new entry. In other embodiments, when the predefined threshold is reached, AP 320 will automatically expand the threshold to accommodate the overflow entries.

In some embodiments, the whitelist of the wall garden may be associated with a timestamp indicating when the captive portal web page has been last modified. Each time when a response page from captive portal web site is received, AP 320 will retrieve a timestamp from the HTTP response, for example:
Last-Modified: Tue, 15 Nov 2010 12:45:26 GMT

If the retrieved timestamp matches the timestamp associated with the whitelist, then AP 320 will not further analyze and process the response from captive portal. However, if the retrieved timestamp is more recent than the timestamp associated with the whitelist, AP 320 will start the analysis and process as described above to generate the updated dynamic whitelist. After the updated whitelist is generated, AP 320 will substitute the retrieved timestamp for the previously existed timestamp associated with the whitelist.

### Dynamic Walled Garden Process

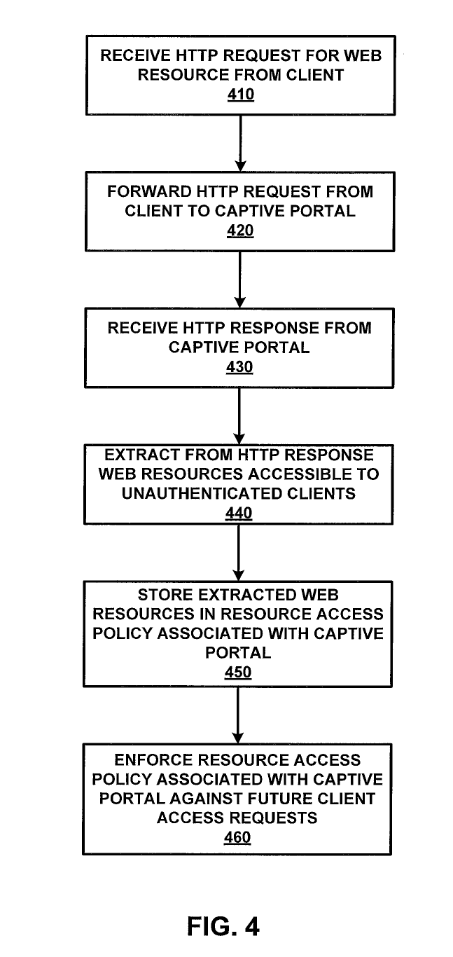

FIG. 4 is a flowchart illustrating an exemplary process of dynamic walled garden. During operation, a network device, such as an access point, receives an HTTP request for a web resource from a wireless station or client (operation 410).

If a walled garden or whitelist corresponding to a pre-configured captive portal is pre-existing, the network device may optionally determine that the wireless station or client has not passed authentication. The network device may also extract from the HTTP request the web resource that the wireless station or client attempts to access. Then, the network device determines whether access to the web resource by the unauthenticated wireless station or client is permitted based on the pre-existing walled garden or whitelist. If so, the network device will forward the HTTP request to the web resource.

If not, the network device will then look up address for a pre-configured external captive portal server, and forwards the HTTP request from the wireless station or client to the captive portal server (operation 420). The captive portal server will typically reply with an HTTP response. Next, the network device receives the HTTP response from the captive portal server (operation 430). Furthermore, the network device can extract, from the received HTTP response, web resources accessible to unauthenticated wireless stations, users, or clients (operation 440). In some embodiments, the network device can extract web resources from the HTTP response by first scanning source code of the HTTP response to detect a tag comprising a Uniform Resource Locator (URL) link to a web resource. If a URL link is detected, the network device will then parse the URL link to retrieve a domain name associated with the web resource. If the domain name does not exist in the resource access policy, the network device will store the domain name in the resource access policy such that future access to the web resource from unauthenticated clients will be granted properly. In some embodiments, the network device also removes sub domain names, web file names, duplicated domain names, etc. while extracting the domain name associated with the accessible web resources.

Moreover, the network device stores the extracted web resources in a resource access policy associated with the captive portal (operation 450). In some embodiments, the resource access policy includes a whitelist; and each extracted web resource corresponds to an entry in the whitelist. In some embodiments, each entry is further associated with a timestamp indicating the last time the web resource was accessed or updated in the whitelist. Moreover, the whitelist may have a pre-defined threshold capacity. When the threshold capacity is reached, the network device will substitute new web resource in the walled garden associated with the captive portal for the least recently used entry. For example, in one embodiment, the network device can maintain a timestamp, which corresponds to when a previously received HTTP response from the captive portal had been last modified. Note that such information is available through the “last-modified” field of the HTTP response. Furthermore, the network device receives another timestamp indicating when the current HTTP response has been last modified. The network device can then compare the two timestamps to determine whether there have been any recent changes since the whitelist or walled garden associated with the captive portal was last updated. If there are new changes, the network device will update the whitelist as well as replacing the previous timestamp with the new timestamp to reflect the update. Otherwise, the network device will not update the whitelist, because there have not been any changes in the captive portal's HTTP response since the whitelist was last updated.

Thus, when future HTTP requests are received at the network device from wireless clients, the network device will enforce the resource access policy associated with the captive portal, which includes the extracted web resources, against those requests (operation 460).

### Dynamic Walled Garden System

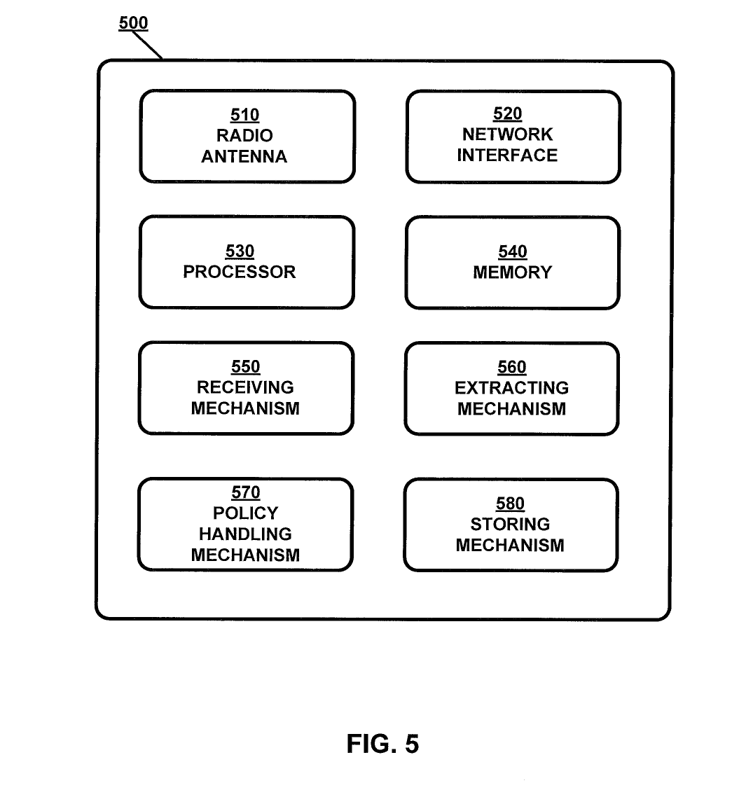

FIG. 5 is a block diagram illustrating a system for dynamic walled garden according to embodiments of the present disclosure.

Operating as a node in a wireless digital network, network device 500 includes at least one or more radio antennas 510 capable of either transmitting or receiving radio signals or both, a network interface 520 capable of communicating to a wired or wireless network, a processor 530 capable of processing computing instructions, and a memory 540 capable of storing instructions and data. Moreover, network device 500 further includes a receiving mechanism 550, a forwarding mechanism 560, a policy handling mechanism 570, and a storing mechanism 580, all of which are coupled to processor 530 and memory 540 in network device 500. Network device 500 may be used as a client system, or a server system, or may serve both as a client and a server in a distributed or a cloud computing environment.

Radio antenna 510 may be any combination of known or conventional electrical components for receipt of signaling, including but not limited to, transistors, capacitors, resistors, multiplexers, wiring, registers, diodes or any other electrical components known or later become known.

Network interface 520 can be any communication interface, which includes but is not limited to, a modem, token ring interface, Ethernet interface, wireless IEEE 802.11 interface, cellular wireless interface, satellite transmission interface, or any other interface for coupling network devices.

Processor 530 can include one or more microprocessors and/or network processors. Memory 540 can include storage components, such as, Dynamic Random Access Memory (DRAM), Static Random Access Memory (SRAM), etc. In some embodiments, memory 540 stores a whitelist.

Receiving mechanism 550 receives one or more network frames via network interface 520 or radio antenna 510. The received network frames may include, but are not limited to, requests and/or responses, beacon frames, management frames, control path frames, and so on, as described in the present disclosure. In some embodiments, receiving mechanism 550 can an HTTP request or response from a wireless client or a captive portal. In one embodiment, receiving mechanism 550 receives an HTTP request from an unauthenticated wireless client to access a web resource, such as a web page. In another embodiment receiving mechanism 550 receives an HTTP response from a captive portal. The HTTP response includes one or more web resources in a walled garden associated with the captive portal. That is, the one or more web resources are the only web resources accessible to any unauthenticated clients. In addition, receiving mechanism 550 can also receive a timestamp indicating when a corresponding HTTP page was last modified.

Extracting mechanism 560 can extract web resources, such as web domain names, from an HTTP page. Specifically, extracting mechanism 560 can scan the source code of the HTTP response page received from a captive portal to detect a tag that indicates a URL link to a web resource. For example, the tag may be associated with one or more of a text, an image, an icon, a web form, a control, an object, etc. In one embodiments, the tag may include certain keywords, such as “src,” “href,” “action,” etc., which indicates that the tag's value might include a URL link to a web resource. If such tag is detected, extracting mechanism 560 can parse the URL link to retrieve a domain name associated with the web resource. Extracting mechanism 560 can then determine whether the extracted domain name is pre-existing in a resource access policy associated with the captive portal. If the domain name is not pre-existing, extracting mechanism 560 will add the domain name to the resource access policy to allow future access to the web resource in the walled garden from unauthenticated clients. Note that, in some embodiments, extracting mechanism 560 may further remove from the URL link any sub domain names, web page/file names, duplicated domain names, etc.

Policy handling mechanism 570 generally handles resource access policies. For example, policy handling mechanism 570 is capable of enforcing a resource access policy based on the web resources extracted by extracting mechanism 560 from HTTP response, which is received from the captive portal by receiving mechanism 550. In particular, policy handling mechanism 570 can determine whether access to a web resource by the unauthenticated client is permitted based on the resource access policy. If access is not permitted, then policy handling mechanism 570 will deny access and redirect the wireless client to captive portal. By doing so, policy handling mechanism 570 can effectively restrict web resource access from unauthenticated clients to the walled garden associated with the captive portal, i.e., the set of extracted web resources.

Moreover, policy handling mechanism 570 can determine whether, when, and how to update the resource access policy. For example, policy handling mechanism 570 can compare a first timestamp with the second timestamp. On the one hand, the first timestamp indicates when a previously received HTTP response from the captive portal had been last modified. On the other hand, the second timestamp indicates when a recently received HTTP response from the same captive portal has been last modified. If the second timestamp is more recent than the first timestamp, then policy handling mechanism 570 will update the resource access policy based on the current or most recent HTTP response received from the captive portal.

Storing mechanism 580 can store one or more resource access policies. In some embodiments, storing mechanism 580 stores the resource access policies in a list. Each entry in the list corresponds to a web resource in the walled garden that is accessible to unauthenticated wireless clients. In some embodiments, each entry may also include a timestamp indicating when the corresponding web resource was last accessed by a wireless client, or last updated by the network device 500. In one embodiment, the list is a whitelist with a pre-defined threshold value. Further, when the pre-defined threshold value is reached, storing mechanism 580 will store a new entry, for example, by substituting the new entry for a least recently used entry in the list.

Receiving mechanism 550, determining mechanism 560, policy handling mechanism 570, and storing mechanism 580 collectively operation with each other to dynamically process access policies regarding walled garden.

According to embodiments of the present disclosure, network services provide by managed network device 500 include, but are not limited to, an Institute of Electrical and Electronics Engineers (IEEE) 802.1x authentication to an internal and/or external Remote Authentication Dial-In User Service (RADIUS) server; an MAC authentication to an internal and/or external RADIUS server; a built-in Dynamic Host Configuration Protocol (DHCP) service to assign wireless client devices IP addresses; an internal secured management interface; Layer-3 forwarding; Network Address Translation (NAT) service between the wireless network and a wired network coupled to the network device; an internal and/or external captive portal; an external management system for managing the network devices in the wireless network; etc.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “access point” (AP) generally refers to receiving points for any known or convenient wireless access technology which may later become known. Specifically, the term AP is not intended to be limited to IEEE 802.11-based APs. APs generally function to allow wireless devices to connect to a wired network via various communications standards.

As used herein, “wireless station” (STA) or “wireless client” generally refers to a portable or mobile wireless communication device or other hardware designed to communicate over a wireless communication channel. A wireless station or client device can physically move around but at any given time may be mobile or stationary. The terms “station,” “client,” “wireless station,” “wireless client,” or “STA” are used interchangeably in the present disclosure.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. The description is this to be regarded as illustrative rather than limiting.

What is claimed is:

1. A method comprising:
receiving, at a first network device, an Hypertext Transfer Protocol (HTTP) response from a second network device, wherein the HTTP response comprises one or more web resources;
extracting, by the network device, the web resources from the HTTP response; and
enforcing, by the network device, an access policy based on the extracted web resources.

2. The method of claim 1,
wherein the second network device corresponds to a captive portal; and
wherein the one or more web resources are associated with a walled garden configured for the captive portal, where in the walled garden comprises only web resources accessible to unauthenticated clients.

3. The method of claim 2, further comprising:
receiving, by the network device, an HTTP request from an unauthenticated client to access a web resource;
determining, by the network device, whether access to the web resource by the unauthenticated client is permitted based on the access policy; and
in response to access to the web resource not being permitted, forwarding, by the network device, the HTTP request to the second network device.

4. The method of claim 2, wherein the access policy comprises a whitelist whose entries correspond to the one or more web resources associated with the wall garden.

5. The method of claim 4,
wherein the whitelist is associated with a threshold; and
wherein a least recently used entry of the whitelist is substituted by a new entry.

6. The method of claim 1, wherein enforcing the access policy based on the extracted web resources further comprises:
storing, by the network device, the extracted web resources in the access policy; and
restricting, by the network device, web resource access from unauthenticated clients to the extracted web resources.

7. The method of claim 1, wherein extracting the web resources from the HTTP response further comprises:
scanning, by the network device, source code of the HTTP response to detect a tag comprising a Uniform Resource Locator (URL) link to a web resource;
parsing, by the network device, the URL link to retrieve a domain name associated with the web resource; and
responsive to the domain name not being existed in the access policy, storing, by the network device, the domain name in the access policy to allow future access to the web resource from unauthenticated clients.

8. The method of claim 7, further comprising:
removing, by the network device, from the URL link one or more of sub domain names, web file names, and duplicated domain names.

9. The method of claim 8, wherein the tag is associated with one or more of a text, an image, an icon, an object, a control, and a web form.

10. The method of claim 7, further comprising:
maintaining, by the network device, a first timestamp corresponding to when a previously received HTTP response had been last modified;
receiving, by the network device, a second timestamp indicating when the HTTP response has been last modified;
comparing, by the network device, the first timestamp with the second timestamp; and
in response to the second timestamp being more recent than the first timestamp, updating the access policy based on the HTTP response.

11. A first network device comprising:
a processor;
a memory;
a receiving mechanism coupled to the processor, the receiving mechanism to receive an Hypertext Transfer Protocol (HTTP) response from a second network device, wherein the HTTP response comprises one or more web resources;
an extracting mechanism coupled to the process, the extracting mechanism to extract web resources from the HTTP response; and
a policy handling mechanism coupled to the process, the policy handling mechanism to enforce an access policy based on the extracted web resources.

12. The first network device of claim 11,
wherein the second network device corresponds to a captive portal; and
wherein the one or more web resources are associated with a walled garden configured for the captive portal, where in the walled garden comprises only web resources accessible to unauthenticated clients.

13. The first network device of claim 12, wherein the policy handling mechanism further to:
receive an HTTP request from an unauthenticated client to access a web resource;
determine whether access to the web resource by the unauthenticated client is permitted based on the access policy; and
forward the HTTP request to the second network device in response to access to the web resource not being permitted.

14. The first network device of claim 12, wherein the access policy comprises a whitelist whose entries correspond to the one or more web resources associated with the wall garden.

15. The first network device of claim 14,
wherein the whitelist is associated with a threshold; and
wherein a least recently used entry of the whitelist is substituted by a new entry.

16. The first network device of claim 11, further comprises:
a storing mechanism coupled to the processor, the storing mechanism to store extracted web resources in the access policy; and
wherein the policy handling mechanism further to restrict web resource access from unauthenticated clients to the extracted web resources.

17. The first network device of claim 11, wherein the extracting mechanism further to:
scan source code of the HTTP response to detect a tag comprising a Uniform Resource Locator (URL) link to a web resource;
parse the URL link to retrieve a domain name associated with the web resource; and
store the domain name in the access policy to allow future access to the web resource from unauthenticated clients in response to the domain name not being existed in the access policy.

18. The first network device of claim 17, wherein the extracting mechanism further to:
remove from the URL link one or more of sub domain names, web file names, and duplicated domain names.

19. The first network device of claim 18, wherein the tag is associated with one or more of a text, an image, an icon, an object, a control, and a web form.

20. The first network device of claim 17,
wherein the storing mechanism further to maintain a first timestamp corresponding to when a previously received HTTP response had been last modified;
wherein the receiving mechanism further to receive a second timestamp indicating when the HTTP response has been last modified; and
wherein the policy handling mechanism further to:
compare the first timestamp with the second timestamp; and
update the access policy based on the HTTP response in response to the second timestamp being more recent than the first timestamp.

21. A non-transitory computer-readable storage medium storing embedded instructions that are executed by one or more mechanisms implemented within a network device to perform a plurality of operations comprising:
receiving an Hypertext Transfer Protocol (HTTP) response from a network device, wherein the HTTP response comprises one or more web resources;
extracting the web resources from the HTTP response; and
enforcing an access policy based on the extracted web resources.
